(19) United States
(12) Patent Application Publication
(10) Pub. No.: US 2007/0195717 A1
(43) Pub. Date: Aug. 23, 2007

(54) Creating A Bridge Clip For Seamless Connection Of Multimedia Sections Without Requiring Recording

(75) Inventors: Serhiy Tkachenko, Eindhoven (NL); Arie Koene, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,859

(22) PCT Filed: Apr. 11, 2005
(86) PCT No.: PCT/IB05/51184

§ 371 Date: Oct. 12, 2006

(30) Foreign Application Priority Data
Apr. 15, 2004 (EP) 04101539.7

(51) Int. Cl. H04L 12/16

(52) U.S. Cl. 370/260

(57) ABSTRACT

The invention concerns a method, devices and a computer program code (10) bridging multimedia stream sections. The method comprises detecting user-selected switching from a first (TS1) to a second section (TS2) at an exit time (USEX) of the first section and an entry time (USEN) of the second section, determining, based on the exit time, an exit location (AEX) having a sequence start marker, selecting all media packets (V₂, A₂) in the first section associated with the start marker and possible media packets (A,) provided after the exit location associated with previous sequences, creating a sequence end marker (E) for selected packets, determining, based on the entry time, an entry location (AEN) having a sequence start marker, selecting stream control information (SC) provided before the entry location, and creating a bridge clip (BC) comprising copied selected media packets, the sequence end marker, copied selected stream control information and possible filling packets (N).

### TECHNICAL FIELD

The present invention is generally related to manipulating multimedia data streams and more particularly to a method, devices and a computer program product for bridging two multimedia stream sections.

### BACKGROUND OF THE INVENTION

In recent years there have been developed a number of standards for recording multimedia data on data carriers, examples of such standards being DVD (Digital Versatile Disc) and Blu-ray disc video. In for instance Blu-ray it is possible to allow a user to seamlessly connect together two streams or clips provided on a Blu-ray disc.

The user does this by manipulating a so-called playlist, which list points at streams or clips that are to be played. One way of providing a seamless connection is by using a so-called bridge clip, which is created from the two streams and stored on the disc. The inclusion of a bridge clip then allows the user to seamlessly jump from a position in a first of the clips to another position in another of the clips without having to change the original clips.

One way of doing this is described in EP-1198133, which describes the creation of a bridge clip from material in the first clip and material in the second clip. In the creation of this bridge clip, however, some of the data of the original clips are recoded before being provided in the bridge clip. Such recoding is fairly complex, requires quite heavy processing and is therefore expensive by nature as well as slow. This type of bridge clip creation is therefore normally suitable for professional editing of multimedia streams.

However it would be interesting to provide this type of functionality also within a consumer market, in which case there is a need for a less complex way of providing a bridge clip in multimedia editing situations.

### SUMMARY OF THE INVENTION

The present invention is therefore directed towards solving the above-mentioned problem of providing bridge-clips in a more simple way in for instance consumer equipment.

One object of the present invention is thus to provide a method of providing bridge-clips in a more simple way that do not require recoding of multimedia streams.

According to a first aspect of the present invention, this object is achieved by a method of bridging two multimedia stream sections comprising the steps of:

detecting user-selected switching from a first to a second section at a certain exit time of the first section and a certain entry time of the second section,

determining an exit location based on the user selected exit time in the first section, which exit location has a sequence start marker,

selecting all media packets in the first section associated with the sequence start marker and possible media packets provided after the exit location associated with previous sequences in the first section,

creating a sequence end marker for selected media packets of the first section,

determining an entry location based on the user-selected entry time in the second section, which entry location has a sequence start marker,

selecting stream control information provided in the second section before the entry location, and

creating a bridge clip comprising copies of said selected media packets in the first section, the sequence end marker, a copy of said selected stream control information as well as possible filling packets,

such that the bridge clip can be played between the entry and exit locations for providing seamless connection between the two sections.

Another object of the present invention is to provide a device that creates bridge-clips in a simple way that does not require recoding of multimedia streams.

According to a second aspect of the present invention, this object is achieved by a device for bridging two multimedia stream sections provided on a storage medium (18) and comprising:

a reading and a writing unit for reading and writing multimedia data on the storage medium, and

a control unit for manipulating at least one multimedia stream provided on the storage medium,

wherein the control unit is arranged to:

detect user-selected switching from a first to a second section at a certain exit time of the first section and a certain entry time of the second section,

determine an exit location based on the user selected exit time in the first section, which exit location has a sequence start marker,

select all media packets in the first section associated with the sequence start marker and possible media packets provided after the exit location associated with previous sequences in the first section,

create a sequence end marker for selected media packets of the first section,

determine an entry location based on the user selected entry time in the second section, which entry location has a sequence start marker,

select stream control information provided in the second section before the entry location, and

create a bridge clip comprising copies of said selected media packets in the first section, the sequence end marker, a copy of said selected stream control information as well as possible filling packets,

such that the bridge clip can be played between the entry and exit locations for providing seamless connection between the two sections.

Another object is to provide a multimedia data presentation device that creates bridge-clips in a simple way that does not require recoding of multimedia streams.

This object is achieved according to a third aspect of the present invention by a multimedia data presentation device comprising a device for bridging two multimedia stream sections according to the second aspect of the invention.

Another object of the present invention is to provide a computer program product that creates bridge-clips in a simple way and that does not require recoding of multimedia streams.

According to a fourth aspect of the present invention, this object is achieved by a computer program product to be used on a computer for bridging two multimedia stream sections and comprising a computer program code for making the computer execute, when said code is loaded into the computer, the following functions:

detect user-selected switching from a first to a second section at a certain exit time of the first section and a certain entry time of the second section,

determine an exit location based on the user selected exit time in the first section, which exit location has a sequence start marker,

select all media packets in the first section associated with the sequence start marker and possible media packets provided after the exit location associated with previous sequences in the first section,

create a sequence end marker for the selected media packets of the first section,

determine an entry location based on the user selected entry time in the second section, which entry location has a sequence start marker,

select stream control information provided in the second section before the entry location, and

create a bridge clip comprising copies of said selected media packets in the first section, the sequence end marker, a copy of said selected stream control information as well as possible filling packets,

such that the bridge clip can be played between the entry and exit locations for providing seamless connection between the two sections.

Claim 2 is directed towards providing the exit and entry locations as the locations that are closest to the user-selected exit and entry times in order to minimize the offset from the desired exit and entry times.

According to claim 3, the selected stream control information is the closest information in previous sections of the second section. In this way the most relevant information is used and unnecessary searching is avoided.

Claim 4 is directed towards including in the bridge clip a number of media packets of the second section after the actual entry point, which might be necessary in order to meet requirements of the recording standard used.

Claim 5 is directed towards including in the bridge clip a number of media packets of the first section before the actual exit point, which might be necessary in order to meet requirements of the recording standard used.

According to claim 6, the media packets include video packets, the sequence end marker being provided after the last video packet associated with the sequence start marker. This is done in order to clearly define the end of the video information originating from the first section, which might also be necessary in order to meet requirements of the recording standard used.

According to claims 7 and 8, null packets are inserted in the bridge clip between non-selected media packets and selected audio packets originating from the first section or packets originating from the second section, which might be necessary in order to meet requirements of the recording standard used.

Claim 9 is directed towards using overhead data in the form of entry point maps in locating sequence start markers, which makes the locating process fast and efficient.

Claim 10 is directed towards creating an entry point map for the bridge clip based on entry point maps of the first and second sections, which might be necessary in order to meet requirements of the recording standard used.

Claims 11 and 12 are directed towards bridging sections provided in the same stream and in different streams, respectively.

With the present invention, the creation of bridge-clips is achieved, without the need to recode multimedia streams, but by just copying and the possible addition of null packets and/or stream control packets. Because of this, the bridging is enabled at small cost and without the complexity associated with said recoding. The creation of a bridge-clip is furthermore fast and can be performed without any perceivable delays to the user. The invention furthermore does not need an encoder for its implementation, which means that it can be provided in an overall simpler and cheaper device.

The basic idea of the invention is to detect a user-entered exit time from a first multimedia stream section to an entry time to a second multimedia stream section, determine an exit location based on the user-selected exit time and an entry location based on the user-selected entry time, which entry and exit locations each have a sequence start marker, select all media packets associated with the sequence start marker and possible media packets provided after the exit location associated with previous sequences in the first section, create a sequence end marker for selected media packets of the first section, select stream control information provided in the second section before the entry location, and create a bridge clip comprising copies of said selected media packets in the first section, the sequence end marker, said selected stream control information as well as possible filling packets. In this way the bridge clip can be played between the entry and exit locations for providing seamless connection between the two sections.

The above-mentioned and other aspects of the invention will be apparent from and elucidated with reference to the embodiments described hereinafter.

### BRIEF DESCRIPTION OF THE DRAWINGS

The present invention will be further described in relation to the accompanying drawings, in which:

FIG. 1 shows a block schematic of a multimedia presentation device comprising a device for bridging two multimedia stream sections according to the present invention,

FIG. 2 schematically shows two transport streams that are to be bridged,

FIG. 3 schematically shows the creation of a bridge clip from the two transport streams according to the present invention, and

FIG. 4 schematically shows a computer program product in the form of a CD ROM disc having a computer program code for performing the method according to the present invention.

### DETAILED DESCRIPTION OF THE INVENTION

The present invention is generally directed towards seamlessly interconnecting sections of multimedia streams without recoding of the multimedia content. In the following a system for providing this facility will be described in relation to MPEG-coded multimedia data in the form of MPEG transport streams that are stored on an optical disc according to the Blu-ray standard. It should however be realized that the invention is not limited to Blu-ray or even MPEG, but can be used on other standards having suitable similar properties. The invention is furthermore not limited to such multimedia streams being provided on an optical disc, but includes storage of such multimedia streams on any suitable storage medium, like hard discs or memory sticks.

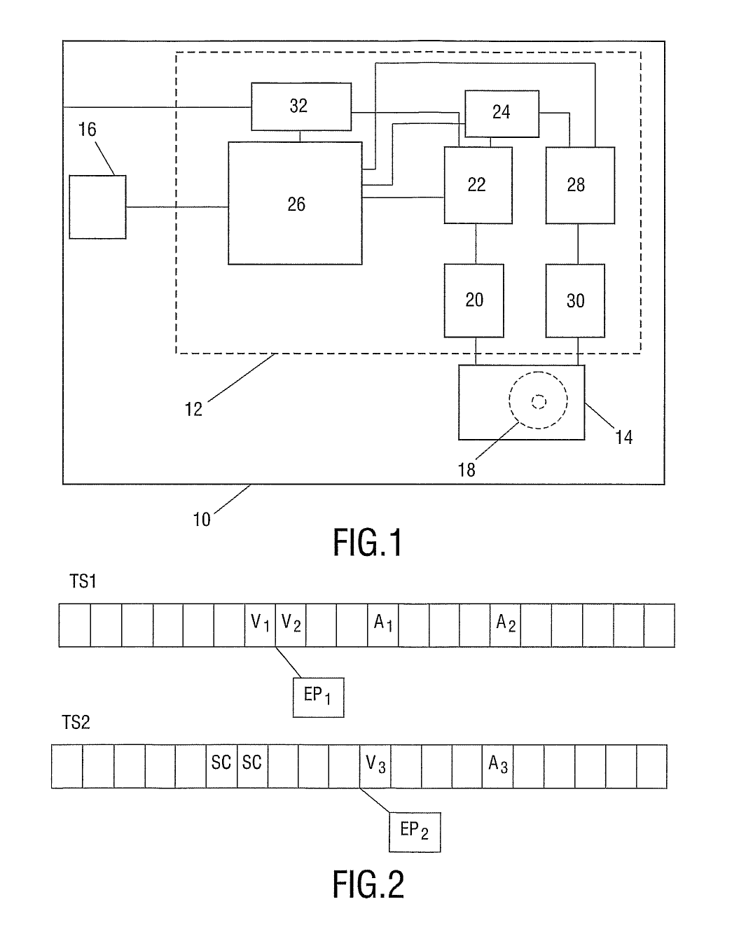

FIG. 1 shows a block schematic of a multimedia presentation device 10 in the form of a simplified Blu-ray player. The player includes an optical disc drive 14 arranged to receive a Blu-ray disc 18 on which is stored a number of multimedia streams coded according to the Blu-ray standard. The disc drive 14 is connected to a device 12 for bridging two multimedia stream sections in the form of a Blu-ray coder/decoder, which device 12 is indicated by a dashed box. A user interface unit 16 is connected to a control unit 26 of the device 12 in order to allow a user to make selections of multimedia streams or clips to be played and also to bridge one stream with another in a seamless fashion. The device 12 therefore comprises a reading unit 20 connected to the disc drive 14 for reading information on the disc 18. The reading unit 20 is furthermore connected to a stream separating unit 22, which removes additional data that is encoded with a transport stream of MPEG multimedia data. The stream separating unit 22 is connected to the control unit 26, to a buffer 24 and to a multimedia decoding unit 32, which multimedia decoding unit 32 provides decoded multimedia signals, which in this embodiment are decoded MPEG video and audio signals for a television set. In order to write data onto the disc 18, a writing unit 30 is connected to the disc drive 14, which writing unit 30 is further connected to a stream combining unit 28, and the stream combining unit 28 is connected to both the control unit 26 and the buffer 24.

In FIG. 1 the device 12 is provided for only playing multimedia data in order to better describe the invention. It should however be realised that it could just as well be provided with actual multimedia recording facilities, in which case there would be required a multimedia coding unit. The multimedia decoding unit 32 is a standard MPEG decoder, which separates the audio and video stream from each other and decodes the coded video and audio information. It should also be realised that there might be several buffers provided for temporary storage of different multimedia streams.

FIG. 2 schematically outlines two transport streams TS1 and TS2 or two video clips, which are retrieved from the disc 18. The streams include a number of multimedia packets grouped into frames. In the first stream TS1 there is a first frame V₁ of video packets next to another frame of video packets V₂. Spaced from this frame V₂ there are a number of audio packets A₁, which are associated with the video frame V₁, and yet further forward there are a number of audio packets A₂, which are associated with the video frame V₂. The video frame V₂ has a first data packet that has a section start marker or section start code, which indicates the start of a section having a GOP (Group of Pictures) I-frame. This means that this packet has all video information necessary for showing a certain scene. The packet furthermore has a timestamp and is associated with an entry point table EP₁ provided as overhead information in relation to the first transport stream TS1 and thus outside this transport stream, and including such information as the number of packets in the sequence. This entry point table EP₁ directly points at the sequence start code, which makes it easy to locate.

The second transport stream TS2 includes a number of stream control packets SC, which can be PAT (Program Association Table), PMT (Program Map Table) or PCR (Program Clock Reference) packets according to the Blu-ray standard which are separated from a frame of video packets V₃, wherein the first packet of this frame also has a data packet that has a section start code, a timestamp and is associated with an entry point table EP₂ provided as overhead information in relation to and outside the second transport stream TS2. This frame V₃ thus also has a GOP I-frame. At a distance from the video frame V₃ there is provided a number of audio packets A₃ associated with this video frame V₃. The reason for providing audio packets distanced from the video packets is that the processing of audio and video in the decoder 32 takes up different amounts of time. The end result is however that these should be provided to the user so as to be synchronized with each other.

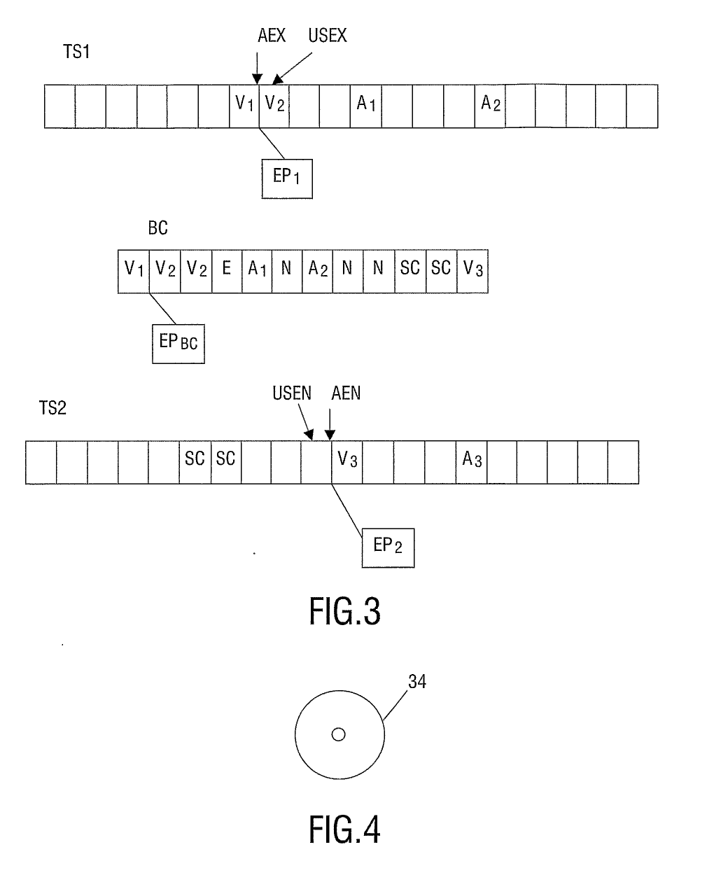

An embodiment of the present invention will now be described with reference being made to FIGS. 1, 2 and 3, where FIG. 3 shows a schematic view of the transport streams TS1 and TS2 as well as a bridge clip BC that is created according to the invention.

A user wanting to play a piece of multimedia can select this by editing a playlist provided by the control unit 26. For the sake of explaining the present invention, it is assumed that the user has selected the multimedia stream TS1, which is stored on the disc 18, for playing. In this case the reading unit 20 reads the data from the disc, the stream separating unit 22 separates overhead data, such as the entry point map EP₁, from the transport stream TS1 and provides this information to the control unit 26. The rest of the data, i.e. the transport stream TS1, is forwarded to the decoder 30, which decodes the stream in a normal and well-known fashion.

As mentioned before, the user can set up a playlist, where he for instance wants to play the first transport stream TS1 first and then the second transport stream TS2. This playlist is entered using the interface 16. One option that exists is that the user can select to bridge the transport streams TS1 and TS2, i.e. connect the first transport stream TS1 with the second transport stream TS2, somewhere in the middle or vice versa. In the present case this possible selection is one that should not influence or change the transport streams TS1 and TS2, i.e. they should be possible to play to the full extent at a later time even though the user selects to make a bridging.

When the user makes such a selection, he selects an exit time from the first stream and an entry time into the second stream. These selections are made via the interface 16 and thus detected by the control unit 26. As a result of these selections, the control unit 26 furthermore enters markers or points in the form of timestamps into the streams TS1 and TS2, which are indicated by a user-selected out time or exit time USEX in the first stream TS1 and a user-selected in time or entry time USEN in the second stream TS2 in FIG. 3.

The control unit 26 then looks forwards and backwards in the first stream TS1 around the user-selected exit time for a section start code. This is done using the corresponding entry point tables associated with the stream, which the control unit 26 has received from the stream separating unit 22. The control unit 26 then detennines an actual exit location AEX of the first stream TS1, which points to the first video packet of the frame V₂. It thus connects the user-selected exit point USEX with this section start code. The location selected is the one that is closest to the user-selected exit time in either direction, i.e. backwards or forwards, and thus the closest frame that has a GOP I-frame. Because of the Blu-ray standard this change is never more than 0.5 seconds, which is exact enough for most consumer applications. The control unit 26 also selects a number of multimedia packets to be used in the bridging process. It selects a number of video packets of the frame V₂ associated with this section start code as well as all the audio packets A₂ associated with this section start code. The frame V₂ contains the last video packet of the first stream TS1 that is to be presented. It also selects possible media packets associated with previous section start codes provided between the pointer and the last audio packet of A₂. In the preferred embodiment the type of packets selected here are audio packets. These selected packets have timestamps that are equal to or smaller than the timestamp of frame V₂. Here the packet A₁ is thus also selected, which is associated with the video frame V₁ of a previous section in TS1. A number of packets V₁ before the section start code are also selected. The selected packets are copied to the buffer 24.

In the same manner, the control unit 26 looks at the second stream TS2, in which the control unit 26 has entered an entry point corresponding to the user-selected entry time USEN. It searches for a section start code in both directions, i.e. backwards and forwards from the user-selected entry point USEN, by looking at entry point tables and then identifies the entry point table EP₂ which points at a section start code associated with a video frame V₃, that includes all necessary video information for a scene, i.e. a GOP I-frame. Also this actual entry point AEN is the point having a sequence start code that is the closest to the user-selected entry point USEN. The control unit 26 then makes this point the actual entry point AEN and associates the user-selected entry point USEN with this actual entry location. Thereafter the control unit 26 searches the second transport stream TS2 backwards in order to find the latest streaming control packets SC, i.e. the last such packets before the actual entry location AEN, which it selects. These packets are such packets as PCR packets, PAT packets and PMT packets. The control unit 26 furthermore selects a number of video packets of the frame V₃ associated with the actual entry location. The control unit 26 then copies the selected packets into the buffer 24.

Once all this information has been copied into the buffer from the two transport streams, the control unit 26 goes on and creates a bridge clip BC out of the data in the buffer 24. The bridge clip BC starts with the extra packets V₁ followed by the packets V₂. Thereafter it creates and places an end of section marker or code E after the last video packet of frame V₂. After this end of section code E, it places the audio packets A₁ associated with previous video frames of TS1. Thereafter it creates one or more null packets N corresponding to the amount of packets provided between A₁ and A₂ in the stream TS1 followed by the audio packets A₂. The control unit 26 then adds a number of null packets N in order to pad the audio packets to an aligned unit boundary, which might be necessary in order to meet requirements of the recording standard used. After these null packets N follow the stream control packets SC of the second stream TS2 as well as the selected packets of the first frame of video data V₃ of the second stream TS2. In case the stream control packets SC include PCR packets with video data, this video data is replaced with padding and adaptation flags (MPEGSYS) in order to satisfy Blu-ray standard restrictions. The extra video packets V₁ and V₃, selected before and after the exit and entry locations, are selected and copied in order to provide a bridge clip having a large enough size for fulfilling the Blu-ray requirements on the smallest clip size. The number of null packets inserted are selected for the same reason. In other standards these video packets might not have to be included in the bridge clip. The thus created bridge clip BC is shown in the middle of FIG. 3.

Now that the bridge clip BC has been created the meta or overhead data associated with it is to be created, i.e. an entry point table EP_{BC}. This entry point table is created from the two previously mentioned entry point tables EP₁ and EP₂ associated with the actual exit location AEX of the first transport stream TS1 and the actual entry location AEN of the second transport stream TS2. The table EP_{BC} is created through copying the entries of EP₁ and EP₂, the actual SPN (Source Packet Number) value being corrected in order to match the actual bridge clip situation. Entries copied from EP₁ are subtracted with the value of SPN of V₂. Entries copied from EP₂ are subtracted with the value of SPN of V₃ minus the number of video packets in the part of the bridge clip originating from the first stream TS1.

Thereafter the control unit 26 ensures that the bridge clip is forwarded from the buffer 24 to the stream combining unit 28 to which the entry point table EP_{BC} is also supplied, and these are combined there and supplied to the writing unit 30 for writing and storage on the disc 18 via the disc drive 14.

In this way the user can seamlessly connect the actual entry and exit locations of the two streams using the bridge clip, by entering the bridge clip into the playlist between TS1 and TS2.

The described method is advantageous since it does not require any recoding of the streamed data for the streams, but only copying together with the addition of null packets or other stream control packets. Because of this, the bridging process is enabled at small cost and without the above-mentioned complexity. It is furthermore fast and can be performed without any perceivable delays to the user. When the user wants to connect from the first to the second stream, the bridge clip is entered into the playlist and a seamless connection is obtained. The bridging position is probably slightly offset from the one selected by the user, which is hardly noticeable in a consumer environment. The invention furthermore does not need an encoder for its implementation, which means that it can be provided in a simpler and cheaper device, like for instance in a Blu-ray player.

The bridging process was described, in the example above, in relation to sections of two separate streams. It should be realized that bridging can just as well be provided between two different sections of the same stream. The locations of connections could also be chosen virtually anywhere inside the transport streams provided there are section start codes close at hand. In case there is no overhead information at hand, i.e. no entry point tables, the control unit would need to search the actual transport streams to find the section start codes. If there is no such overhead information there will also be no stream separating unit or stream combining unit in the device for bridging multimedia stream sections.

The control unit is preferably provided in the form of a processor with an associated program code for performing the method according to the invention. This program code can also be provided on a data carrier, such as a data carrier 34 in the form of a CD Rom disc as shown in FIG. 4. The program code can furthermore be provided on a server and downloaded into the multimedia presentation device. The multimedia presentation device furthermore need not be a Blu-ray disc player, but can for instance also be a computer like a PC (Personal Computer).

It should be emphasized that the term “comprises/comprising” when used in this specification is taken to specify the presence of stated features, integers, steps or components, but does not preclude the presence or addition of one or more other features, integers, steps, components or groups thereof. It should furthermore be realized that reference signs appearing in the claims should in no way be construed as limiting the scope of the present invention.

1. Method of bridging two multimedia stream sections comprising the steps of:
detecting user-selected switching from a first to a second section at a certain exit time (USEX) of the first section (TS1) and a certain entry time (USEN) of the second section (TS2),
determining an exit location (AEX) based on the user-selected exit time in the first section, which exit location has a sequence start marker,
selecting all media packets (V₂, A₂) in the first section associated with the sequence start marker and possible media packets (A₁) provided after the exit location associated with previous sequences in the first section,
creating a sequence end marker (E) for selected media packets of the first section,
determining an entry location (AEN) based on the user-selected entry time in the second section, which entry location has a sequence start marker,
selecting stream control information (SC) provided in the second section before the entry location, and
creating a bridge clip (BC) comprising copies of said selected media packets in the first section, the sequence end marker, a copy of said selected stream control information as well as possible filling packets (N),
such that the bridge clip can be played between the entry and exit locations for providing a seamless connection between the two sections.

2. Method according to claim 1, wherein the actual entry and exit locations are the locations being closest to the user-selected entry and exit times.

3. Method according to claim 1, wherein the selected stream control information is the closest stream control information provided in previous sequences of the second section

4. Method according to claim 1, further comprising the step of selecting a limited number of media packets (V₃) in the second section after the entry location and also providing these in the bridge clip.

5. Method according to claim 1, further comprising the step of selecting a limited number of media packets in the first section provided before the exit location.

6. Method according to claim 1, wherein the media packets comprise video packets (V₁, V₂, V₃) and audio packets (A₁, A₂, A₃) and the sequence end marker in the bridge clip is provided after the last video packet (V₂) associated with the sequence start marker of the exit location.

7. Method according to claim 6, wherein the media packets comprise audio packets (A₁, A₂, A₃), said method further comprising the step of copying non-selected media packets in the first section between said exit location and the last audio packet associated with the sequence start marker and replacing these copied packets with null packets and/or stream control packets.

8. Method according to claim 1, further comprising the step of adding null packets to the packets originating from the second section in the bridge clip.

9. Method according to claim 1, wherein at least said exit location of the first section and the entry location of the second section each comprise an entry point map (EP₁, EP₂), which are used for identifying exit and entry locations.

10. Method according to claim 9, further comprising the step of creating an entry point map (EP_{BC}) for the bridge clip from the entry point maps of the first and second sections.

11. Method according to claim 1, wherein the sections are provided in the same multimedia stream.

12. Method according to claim 1, wherein the sections are provided in two different multimedia streams.

13. Device (12) for bridging two multimedia stream sections provided on a storage medium (18) and comprising:
a reading (20) unit and a writing (30) unit for reading and writing multimedia data on the storage medium (18), and
a control unit (26) for manipulating at least one multimedia stream provided on the storage medium,
wherein the control unit is arranged to:
detect user-selected switching from a first (TS1) to a second (TS2) section at a certain exit time (USEX) of the first section and a certain entry time (USEN) of the second section,
determine an exit location (AEX) based on the user-selected exit time in the first section, which exit location has a sequence start marker,
select all media packets (V₂, A₂) in the first section associated with the sequence start marker and possible media packets (A₁) provided after the exit location associated with previous sequences in the first section,
create a sequence end marker (E) for selected media packets of the first section,
determine an entry location (AEN) based on the user-selected entry time in the second section, which entry location has a sequence start marker,
select stream control information (SC) provided in the second section before the entry location, and
create a bridge clip (BC) comprising copies of said selected media packets in the first section, the sequence end marker, a copy of said selected stream control information as well as possible filling packets,
such that the bridge clip can be played between the entry and exit locations for providing a seamless connection between the two sections.

14. Device according to claim 12, further comprising a stream separating unit (22) and a stream combining unit (28) for providing a stream of additional overhead data related to a multimedia stream.

15. Multimedia data presentation device (10) comprising a device (12) for bridging two multimedia stream sections according to claim 13.

16. Computer program product (34) to be used on a computer for bridging two multimedia stream sections and comprising a computer program code for making the computer execute, when said code is loaded into the computer, the following functions:
detect user-selected switching from a first (TS1) to a second section (TS2) at a certain exit time (USEX) of the first section and a certain entry time (USEN) of the second section,
determine an exit location (AEX) based on the user-selected exit time in the first section, which exit location has a sequence start marker,
select all media packets (V₂, A₂) in the first section associated with the sequence start marker and possible media packets (A₁) provided after the exit location associated with previous sequences in the first section,
create a sequence end marker (E) for the selected media packets of the first section,
determine an entry location (AEN) based on the user-selected entry time in the second section, which entry location has a sequence start marker,
select stream control information (SC) provided in the second section before the entry location, and
create a bridge clip (BC) comprising copies of said selected media packets in the first section, the sequence end marker, a copy of said selected stream control information as well as possible filling packets (N),
such that the bridge clip can be played between the entry and exit locations for providing a seamless connection between the two sections.
